(19) United States
(12) Patent Application Publication
(10) Pub. No.: US 2007/0119221 A1
(43) Pub. Date: May 31, 2007

(54) Addition of Gelling Grade Clays to Direct Applied Nitrogen Solutions to Reduce Nitrogen Loss

(76) Inventor: John Wolford, Tallahassee, FL (US)

Correspondence Address: BASF CATALYSTS LLC, 100 CAMPUS DRIVE, FLORHAM PARK, NJ, 07932, US

(21) Appl. No.: 11/539,744

(22) Filed: Oct. 9, 2006

Related U.S. Application Data
(60) Provisional application No. 60/597,429, filed on Nov. 30, 2005.

(51) Int. Cl. C05C 9/00

(52) U.S. Cl. 71/28

(57) ABSTRACT

The present invention is directed to an improved method of agricultural fertilization said method comprising, applying a water-soluble nitrogen-containing fertilizer composition comprising one or more nitrogen-containing sources and one or more gelling grade clays, to soil, and thereby minimizing nitrogen loss due to volatilization and/or leaching. The present invention is also directed to the water-soluble nitrogen-containing clay composition and a method of preparing said composition.

This patent application claims the benefit of pending U.S. patent application Ser. 60/597,429 filed Nov. 30, 2005 incorporated herein in its entirety.

### FIELD OF THE INVENTION

The present invention relates generally to a method of agricultural fertilization. More specifically, the invention relates to a method of applying a soluble nitrogen fertilizer, to soil, wherein said composition minimizes or reduces nitrogen loss.

### BACKGROUND OF THE INVENTION

In many farming areas, soil is deficient in one or more nutrients required for satisfactory growth of certain crops. As a result, such crops do not give their optimum yield. When such conditions exist, it is common procedure to apply a fertilizer rich in the required nutrient(s).

High-quality and highly concentrated fluid fertilizers of various types are now in wide use throughout the country because they display certain distinct advantages over dry mixes. The advantages of fluid fertilizers are lower shipping and handling costs, more simplified and even distribution to the soil, and the convenience of incorporation of pesticides (e.g., herbicides, insecticides, fungicides, etc.) and micronutrients in fluid fertilizers. Fluid fertilizers may be solutions, slurries, or suspensions. Both slurries and suspensions contain crystals of fertilizer salts in saturated solutions. However, suspensions also contain small amounts of a suspending agent, which keeps the liquid and solid phases homogeneously distributed. Slurry fertilizers generally have been replaced by suspensions because of the far superior storage and handling properties exhibited by suspensions, as will be discussed later.

Liquid fertilizers have been used for many years to provide plant nutrients in a form, which can be easily assimilated by plants and can be easily and evenly applied either into the soil or directly onto the plants. A problem encountered in the preparation and use of liquid fertilizers is the difficulty of maintaining the complete solubility of all the components of the fertilizer solution.

Suspension liquid fertilizers are saturated aqueous solutions of fertilizing substances, which comprise small crystals of the fertilizing substances in suspension. The suspension liquid fertilizers have important advantages over conventional solid fertilizers. They do not give rise to caking problems and, being fluid, are readily applied to the soil. Thus, the suspension liquid fertilizers can be pumped through suitable pipes and directly sprayed onto the soil. Suspending agents, such as attapulgite clay have been found effective for use in these suspension fertilizer solutions to prevent the formation of density-packed precipitate.

Attapulgite is a naturally mined clay. It is a needle-like clay mineral composed of magnesium-aluminum silicate. Major deposits occur naturally in, for example, Georgia and Florida, USA. Attapulgite has very good colloidal properties such as: specific features in dispersion, high temperature endurance, salt and alkali resistance, and also high adsorbing and de-coloring capabilities.

As previously mentioned, the use of attapulgite as a suspending agent is known. For example, U.S. Pat. No. 4,439,223, assigned to Tennessee Valley Authority (TVA), describes a highly concentrated nitrogen suspension fertilizer, which has improved long-term storage and handling properties. This nitrogen suspension fertilizer is made from a mixture of suspended urea crystals, ammonium nitrate, water, and attapulgite clay. The urea crystals remain homogeneously distributed in a saturated solution containing urea and ammonium nitrate. The resulting products, to wit, urea-ammonium nitrate suspension fertilizers, are exceptionally high in grade, low in viscosity, contain small crystals which do not settle, and are capable of being shipped, stored, and handled at extremely low temperatures (0° F. and below).

U.S. Pat. No. 4,885,021, also assigned to Tennessee Valley Authority (TVA), is directed to an approach to storage stability, particularly a reduction in the tendency for caking during storage of freshly prepared urea particles. The approach utilizes a gelling clay as an additive to act as an in situ suspending agent in instances wherein the treated urea particles are utilized in the subsequent production of suspension type fertilizers.

In another example, U.S. Pat. No. 4,304,587 describes an emulsion of an aqueous solution of a nitrogen-phosphorus (N—P) or nitrogen-phosphorus-potassium (N—P—K) fertilizer, attapulgite clay, and an organophosphorus pesticide. According to the patent, the stability of an emulsion containing an organophosphorus pesticide and an N—P or N—P—K fertilizer is substantially enhanced by the inclusion of an attapulgite clay.

In yet another example, U.S. Defense Publication No. T940,014 discloses a process for the production of an improved nitrogen fertilizer suspension by dispersing attapulgite clay and water with a dispersing agent and adding the dispersed clay to the nitrogen solution to cause the clay to gel. The concentration of clay in the dispersed state can be as high as 30 percent, and with a concentration of clay in the gel state (i.e., nitrogen solution) of 2 percent, high gel strength can be obtained with only moderate agitation. According to the publication, the products are useful in making mixed high-nitrogen suspensions that also contain phosphorous and potassium by simply blending the base nitrogen suspension with phosphate base suspension and solid potassium chloride.

U.S. Defense Publication T911,008 discloses a process for the production of improved fluid nitrogen fertilizers by addition of a gelling-type clay and utilizing high-shear agitation for dispersion of the clay. According to the publication, the clay is dispersed in nitrogen solutions, such as urea-ammonium nitrate solution, with a high-shear agitator or centrifugal pump. Products with clay well dispersed, as measured by a gelometer, have improved storage characteristics at low temperatures, may be used for direct application, and give improved suspensions when mixed with fluids containing phosphate and potassium.

Like the previously cited art, the suspension products of the U.S. Defense Publications contain insoluble fertilizer particles, which are typically solids and need to be suspended. Furthermore, Applicant is unaware of attapulgite clay being added to soluble nitrogen solutions for direct application to field soils for the purpose of preventing nitrogen loss.

The most common nitrogen fertilizers in use today are nitrogen solution fertilizers. To provide an adequate supply of these types of fertilizers, the utilization of urea in combination with ammonium nitrate to form nitrogen solutions is widespread because higher nitrogen concentrations can be attained than by using solutions of either of these nitrogen sources separately. A common example of this practice is urea-ammonium nitrate solution (32% by weight nitrogen) produced by mixing together about 35 parts of urea, 45 parts of ammonium nitrate, and 20 parts of water. This solution salts out at about 320° F.; increasing the water content lowers the salting-out temperature, but increases the cost of handling, shipping, storage, and application per unit weight of nitrogen.

Nitrogen solutions are commonly applied to various crop fields as fertilizers to increase crop yields. These nitrogen solutions are usually identified by the amount of nitrogen contained therein, e.g., 28% N, 30% N, and 32% N. Common nitrogen fertilizers include anhydrous ammonia (82% N), urea (45-46% N), ammonium sulfate (21% N), ammonium nitrate (34% N), calcium nitrate (16% N), diammonium phosphate (18% N), and aqueous ammonia (20-25% N), and solutions of urea and ammonium nitrate (28-32% N).

However, the loss of nitrogen to the atmosphere or through runoff and leaching generally occur as unintended consequences of using nitrogen solution fertilizers. There are two basic ways to express nitrogen loss, volatilization and leaching. Surface volatilization of nitrogen occurs when nitrogen breaks down to form ammonium gases and where there is little soil water to absorb them. The rate of surface volatilization can depend on the moisture level, and temperature. Nitrogen leaching results when mobile forms of nitrogen in soil drainage water are transported below the vegetation roots and ultimately find their way to groundwater or neighboring water bodies such as lakes, rivers and ponds. Environmental conditions favorable for nitrogen leaching include coarse-textured soils, abundant precipitation, saturated soils and warm temperatures. In worst-case scenarios, up to two-thirds of the nitrogen in nitrogen solution fertilizer can be lost through volatilization and leaching.

Thus, despite the various forms of nitrogen fertilizers used today, nitrogen loss remains a substantial problem. Due to the high cost of nitrogen sources the loss of nitrogen can be a substantial economic loss. Furthermore, depending upon where the lost nitrogen ends up, the nitrogen can be an environmental hazard, for example if the nitrogen ends up in stream or well water.

The reduction of nitrogen loss would provide an economic advantage by requiring less nitrogen fertilizer to be applied to the crop field, and increase the yield of planted crops. Accordingly, the present invention seeks to provide a method of applying a nitrogen-containing fertilizer to field soil, which minimizes the loss of nitrogen.

### SUMMARY OF THE INVENTION

The present invention relates to an improved water-soluble nitrogen fertilizer and a method of agricultural fertilization, which minimizes or reduces nitrogen loss due to leaching and/or run-off. More specifically, the present invention relates to a water-soluble nitrogen-containing fertilizer composition comprising one or more nitrogen-containing fertilizer sources and a gelling grade clay. The nitrogen-containing/clay mixture can be applied to an agricultural field as a fertilizer, thereby minimizing or reducing nitrogen loss.

Accordingly, the present invention resides in a method of agricultural fertilization, the method comprising the steps of, providing a nitrogen-containing fertilizer composition comprising, one or more water-soluble nitrogen-containing sources and a gelling grade clay, applying said fertilizer composition to an agriculture field, wherein nitrogen loss is minimized.

In another aspect, the invention resides in a method for enhancing crop growth by minimizing or reducing nitrogen loss through the application to field soils of a composition comprising one or more nitrogen-containing sources; and a gelling grade clay.

Other objectives and advantages of the present invention will become apparent from the following description and appended claims.

### DETAILED DESCRIPTION OF THE INVENTION

It has been surprisingly found that gelling-grade clay, e.g., attapulgite, when used as a viscosifying agent in a soluble nitrogen fertilizer composition, minimizes or reduces nitrogen loss due to leaching and/or run-off.

The present invention is directed to an improved method of agricultural fertilization said method comprising, applying a water-soluble nitrogen-containing fertilizer composition comprising one or more nitrogen-containing sources and one or more gelling grade clays, to soil, and thereby minimizing nitrogen loss due to volatilization and/or leaching. The present invention is also directed to the water-soluble nitrogen-containing clay composition and a method of preparing said composition. In one embodiment, the composition of the present invention is a water-soluble nitrogen-containing source physically blended with gelling grade attapulgite clay.

As used herein the term “water-soluble nitrogen-containing fertilizer” or “nitrogen-containing source” can be any known aqueous nitrogen-containing solution or combination of aqueous nitrogen-containing solutions, which will rapidly and completely dissolve in water. The water-soluble nitrogen-containing source of the present invention may include, but is not limited to, anhydrous ammonia, urea, ammonium sulfate, ammonium nitrate, calcium nitrate, monoammonium phosphate, diammonium phosphate, and aqueous ammonia, and solutions of urea and ammonium nitrate. In one embodiment, the use of a urea and ammonium nitrate solution is exemplified. Other ammonium salts, e.g., ammonium chloride, or ammunonium phosphates; nitrates, e.g., ammonium nitrate, calcium nitrate, sodium nitrate, or potassium nitrate; or substituted ureas, e.g., urea-aldehyde condensates or methylene ureas may also be employed.

The nitrogen content of the final fertilizer can vary from about 5% to about 85% by weight; however, about 15% to about 35% by weight is also exemplified. In one embodiment, the water-soluble nitrogen-containing source is a solution of urea and ammonium nitrate (UAN) (containing, for example, 28, 30, or 32% N). As one of skill in the art will recognize, the final nitrogen content in the water-soluble nitrogen-containing fertilizer composition will vary depending on the total amount of gelling grade clay used in the composition. For example, a water-soluble nitrogen-containing fertilizer composition prepared by the addition of 1.5% by final weight attapulgite clay to a 32% UAN nitrogen-containing source may result in a final nitrogen content of about 30%.

The gelling grade clay useful as a component of the invention may be any known gelling grade clay. Examples of suitable clays include, but are not limited to, kaolinite, halloysite, vermiculite, chlorite, attapulgite, smectite, montmorillonite, illite, saconite, sepiolite, polygorskite, Fuller's earth, and mixtures thereof. In one embodiment, the clay is selected from a group consisting of attapulgite clay, montmorillonite clay, sepioloite clay, and mixtures thereof. In another embodiment, gelling grade attapuligte clay is exemplified.

The term “attapulgite clay” as used herein, is meant to include any of the classes of clays or clay-containing materials based on the mineral attapulgite. This mineral, which can be mined, for example, in Georgia and Florida, is a hydrated aluminum silicate in a lattice structure, which also contains magnesium. The mineral attapulgite is a hydrated magnesium aluminum silicate, with a unique chain structure that imparts to the clay unusual sorptive and colloidal properties. Attapulgite crystals have an acicular configuration and occur as bundles of laths, the individual laths attaining a maximum length of about 4 to 5 microns (typically, 2-3 microns in length), a maximum thickness of about 50 to 100 Angstroms, and a width ordinarily two to three times the thickness. A typical mined sample of such clay might contain 70 percent to 80 percent attapulgite, 10 percent to 15 percent other clays, 4 percent to 8 percent quartz and 1 percent to 5 percent calcite or dolomite.

As used herein, the term “gelling grade attapulgite” refers to and means a specific group of commercially available and appropriately labeled clays, which have been processed so as to possess properties capable of forming gels in liquid systems. For example, gelling grade attapulgite clays differ in properties from other types of attapulgite clays, which are commonly used for decolorizing oils and as filter mediums. The gelling grade attapulgite clays are processed and manufactured specifically for use in production of gels and suspensions in liquid systems and would not be expected to be selected for other uses, especially in view of their gel forming behavior when exposed to aqueous media. Attapulgite clays commercially available from the present assignee include, but are not limited to, Attagel® 20, Attagel® 30, Attagel® 36, Attagel® 40, Attagel® 50, Attagel® 350, Attagel® 370, Attagel® 390, Attaflow® FL, Attaflow® SF. In one embodiment, gelling grade attapulgite clays useful in the practice of the present invention may contain from about 3% to about 15% by weight water, however, from about 9% to about 15% by weight water is also exemplified.

While the use of attapulgite clays in the preparation of suspension liquid fertilizers may be known, it has been unexpectedly found that gelling grade attapulgite clay can be used as a viscosifying agent to minimize nitrogen loss from water-soluble nitrogen-containing fertilizers, when applied to crop fields. The gelling grade attapulgite is present in an amount sufficient for viscosifying said water-soluble nitrogen-containing solution. The amount of clay used will generally be within the range of about 0.1% to about 10.0% by weight, based on the weight of the final fertilizer composition, however, amounts of about 0.5% to about 3% by weight are also exemplified, from about 1% to about 1.5% is also exemplified. The “viscosifying amount,” as used herein, means that amount of a material, i.e., a viscosifying agent, which will increase the viscosity of liquid in question to a degree sufficient to achieve the desired result, for example, reducing or minimizing nitrogen loss due to leaching and/or run-off. The viscosity may depend, to a certain extent, on particle size, pH, and temperature. Optionally, the composition may contain a dispersant. In general, any known dispersant can be used, preferred dispersants include, but are not limited to, tetrasodium pyrophosphate, sodium polyacrylate, sodium hexametaphosphate or sodium silicate.

As one of skill in the art will appreciate, it may be desirable to include one or more additional nutrients in the water-soluble nitrogen-containing attapulgite fertilizer, to minimize the necessity of applying numerous fertilizers to provide the necessary nutrients. However, the present invention is particularly concerned with adding soluble components because it has been surprisingly found that a gelling grade clay can be added to a water-soluble fertilizer composition to increase the viscosity thereof and thereby reduce or minimize nitrogen loss due to leaching and/or run-off.

For example, the fertilizer component may contain a source of available phosphorous, e.g., in the form of a water-soluble phosphate such as ammonium phosphate or a potassium phosphate. A source of available potassium may also be included, e.g., in the form of a water-soluble potassium such as potassium nitrate, potassium phosphate, potassium sulfate, or potassium chloride.

Various other soluble fertilizing substances may be admixed with the solution, e.g., potassium may be added in the form of a soluble potassium compound, such as, soluble potassium salts, potassium chloride or potassium nitrate. Other soluble fertilizing substances may including, but are not limited to, potassium iodine, potassium bromide, potassium hydroxide, potassium carbonate, potassium phosphate, and potassium sulfate. Fully soluble metal salts (i.e., water-soluble metal salts), such as, zinc, manganese, aluminum, iron sulfites, or iron chlorides may also be added to the final water-soluble nitrogen containing attapulgite fertilizer.

The fertilizer component may also include trace elements necessary for satisfactory crop growth, which are sometimes deficient in the soil. Examples are zinc, iron, copper, cobalt, molybdenum, and manganese. Such trace elements may be present as their salts, or as anions such as molybdate or as a complex. For example, iron may be present as a complex with ethylenediamine tetraacetic acid.

Any known method in the art for preparing a mixture of clay and an aqueous nitrogen-containing solution can be used. For example, Salladay, in U.S. Pat. No. 4,617,048 discloses a process for producing urea ammonium nitrate by the addition of dry bentonite clay to a hot solution of urea without dispersants and subsequently adding hot ammonium nitrate solution. Elrod et al, U.S. Pat. No. 4,954,155 disclose sonic energy to disperse clay in fertilizer solutions. In U.S. Pat. No. 5,439,497, Boles recognizes the need for non-caking, free flowing fine particles of ammonium sulfate and discloses the batch mixture of dry attapulgite clay with ammonium sulfate in equipment for mixing solids.

In another embodiment, the composition of the invention can be prepared by simply mixing the individual components by any known mixing means, such as mechanical mixing with a blender. For example, water can be added to dry attapulgite clay and mixed using a blender to form a hydrated or liquid attapulgite composition. A water-soluble nitrogen-containing source can then be added to the hydrated attapulgite composition and further mixed. Additional water may be added to increase the fluidity of the final water-soluble nitrogen-containing attapulgite composition.

In yet another embodiment, dry attapulgite clay can be added directly to the water-soluble nitrogen-containing source, and said composition mixed. In a preferred embodiment, high shear mixing is exemplified.

The process of the invention can be carried out at a wide range of temperatures that are suitable for preparation of the water-soluble nitrogen-containing fertilizer, generally from about 5° C. to about 70° C., preferably about 10° C. to about 60° C., and most preferably 15° C. to 55° C. The process can be carried out under a pressure in the range of from about 0.5 to about 5 atmospheres and preferably under atmospheric pressure. The final composition can be adjusted to a desirable pH. The desired pH can range from about 5 to about 9. One embodiment includes a pH range from about 6 to about 8.

In the practice of the present invention the water-soluble nitrogen-containing attapulgite fertilizer of the invention can be applied to an agricultural field by any know method in the art. For example, the water-soluble nitrogen-containing attapulgite fertilizer can be applied using common fertilizer machinery for spraying agricultural crop fields.

In order that those skilled in the art may better understand how the present invention can be practiced, the following examples are given by way of illustration and not necessarily by way of limitation.

### EXAMPLES

### Example 1

Influence of Attapulgite Clay in an early Postemergence Broadcast Solution of 32% urea-ammonium nitrate (UAN) solution. An attapulgite liquid clay mixture was prepared by adding water and tetrasodium pyrophosphate (TSPP) to Attagel® 350 (a commercially available dry powder of gelling grade attapulgite), a registered trademark of BASF Catalysts LLC. The attapulgite liquid clay mixture was then mixed into a 32% urea-ammonium nitrate (UAN) solution under high shear, to a final concentration of 1% attapulgite. Due to the increase in total volume, the final mixture contains approximately 30% UAN.

The UAN nitrogen fertilizer alone and as a UAN/attapulgite mixture were applied to separate plots of corn at the University of Maryland's Poplar Hill Experiment Station. When the corn was harvested the plot containing the N solution with attapulgite outperformed the plot containing N and no attapulgite.

Nitrogen rate, as applied, was 32 lbs/acre of N broadcast between rows at the 4^{th} Leaf Stage. UAN and UAN/attapulgite was dribbled between rows. Results in bushels per acre are shown in Table 1.

TABLE 1

| Fertilizer Applied | Plot 1 | Plot 2 | Plot 3 | Plot 4 | Average |
|---|---|---|---|---|---|
| Postemergence | 109.3 | 121.4 | 124.1 | 136.2 | 122.7 |
| Application of UAN, no | | | | | |
| attapulgite | | | | | |
| Postemergence | 185.3 | 176.6 | 173.6 | 176.3 | 177.9 |
| Application of UAN | | | | | |
| with 1% attapulgite | | | | | |

### Example 2

Influence of Attapulgite Clay in an early Postemergence Broadcast Solution of 32% urea-ammonium nitrate (UAN) solution. Again, An attapulgite liquid clay mixture was prepared by adding water and tetrasodium pyrophosphate (TSPP) to Attagel® 350 (a commercially available dry powder of gelling grade attapulgite). The attapulgite liquid clay mixture was then mixed into a 32% urea-ammonium nitrate (UAN) solution under high shear, to a final concentration of 1.5% attapulgite. Do to the increase in total volume the final mixture contains approximately 30% UAN.

The UAN nitrogen fertilizer alone and as a UAN/attapulgite mixture were applied to separate plots of corn at the University of Maryland's Poplar Hill Experiment Station. When the corn was harvested the plot containing the N solution with attapulgite outperformed the plot containing N and no attapulgite.

Nitrogen rate, as applied, was 32 lbs/acre of N broadcast between rows at the 4^{th} Leaf Stage. UAN and UAN/attapulgite was dribbled between rows. Results in bushels per acre are shown in Table 2.

TABLE 2

| Fertilizer Applied | Plot A | Plot B | Plot C | Plot D | Average |
|---|---|---|---|---|---|
| 30% UAN, no | 154.5 | 123.4 | 153.4 | 155.6 | 146.7 |
| attapulgite | | | | | |
| 30% UAN, 1.5 | 174.5 | 138.9 | 157.8 | 161.1 | 158.1 |
| attapulgite | | | | | |

What is claimed is:

1. A method for agricultural fertilization, the method comprising the steps of:
a) providing a nitrogen-containing fertilizer composition consisting essentially of:
i) water;
ii) one or more water-soluble nitrogen-containing sources;
iii) about 0.1 to about 10 percent by weight of a gelling grade clay; and
iv) optionally, one or more water-soluble adjuvants;
b) applying said fertilizer composition to an agriculture field;
wherein nitrogen loss is minimized.

2. The method of claim 1, wherein said water-soluble nitrogen-containing source is selected from the group consisting of anhydrous ammonia, urea, ammonium sulfate, ammonium nitrate, calcium nitrate, monoammonium phosphate, diammonium phosphate, aqueous ammonia, and a urea and ammonium nitrate solutions.

3. The method of claim 2, wherein said water-soluble nitrogen-containing source is a urea and ammonium nitrate solutions.

4. The method of claim 1, wherein said gelling grade clay is selected from the group consisting of attapulgite clay, polygorskite clay, montmorillonite clay, sepioloite clay, and mixtures thereof.

5. The method of claim 1, wherein said gelling grade clay is attapulgite.

6. The method of claim 1, wherein said gelling grade clay is used in an amount from of about 0.1% to about 10.0% by weight of said nitrogen-containing fertilizer composition.

7. The method of claim 1, wherein said gelling grade clay is used in an amount from of about 0.5% to about 3.0% by weight of said nitrogen-containing fertilizer composition.

8. The method of claim 1, wherein said water-soluble nitrogen-containing fertilizer composition contains from about 5% to about 85% by weight nitrogen.

9. The method of claim 1, wherein said water-soluble nitrogen-containing fertilizer composition contains from about 15% to about 35% by weight nitrogen.

10. The method of claim 1, wherein said adjuvant comprises one or more water-soluble metal salts.

11. A method for enhancing crop growth by minimizing nitrogen loss through field soil by applying to field soils a composition consisting essentially of:
a) one or more water-soluble nitrogen-containing sources in water;
b) a gelling grade clay; and
c) optionally, one or more water-soluble adjuvants.

12. The method of claim 11, wherein said water-soluble nitrogen-containing source is selected from the group consisting of anhydrous ammonia, urea, ammonium sulfate, ammonium nitrate, calcium nitrate, diammonium phosphate, aqueous ammonia, and a urea and ammonium nitrate solutions.

13. The method of claim 12, wherein said water-soluble nitrogen-containing source is a urea and ammonium nitrate solutions.

14. The method of claim 11, wherein said gelling grade clay is selected from the group consisting of attapulgite clay, montmorillonite clay, sepioloite clay, and mixtures thereof.

15. The method of claim 11, wherein said gelling grade clay is attapulgite.

16. The method of claim 11, wherein said gelling grade clay is used in an amount from of about 0.1% to about 10.0% by weight of said nitrogen-containing fertilizer composition.

17. The method of claim 11, wherein said gelling grade clay is used in an amount from of about 0.5% to about 3.0% by weight of said nitrogen-containing fertilizer composition.

18. The method of claim 11, wherein said water-soluble nitrogen-containing fertilizer composition contains from about 5% to about 85% by weight nitrogen.

19. The method of claim 11, wherein said water-soluble nitrogen-containing fertilizer composition contains from about 15% to about 35% by weight nitrogen.

20. The method of claim 11, wherein said adjuvant comprises one or more water-soluble metal salts.
